(19) United States
(12) Patent Application Publication
(10) Pub. No.: US 2024/0428510 A1
(43) Pub. Date: Dec. 26, 2024

(54) VISUAL INSPECTION METHOD

(71) Applicant: HITACHI, Ltd., Tokyo (JP)

(72) Inventors: Masato TAMURA, Santa Clara, CA (US); Ravigopal VENNELAKANTI, San Jose, CA (US); Rahul VISHWAKARMA, Berkeley, CA (US); Nam HUYN, Milpitas, CA (US); Malarvizhi SANKARANARAYANASAMY, Mountain View, CA (US)

(21) Appl. No.: 18/214,157

(22) Filed: Jun. 26, 2023

(51) Int. Cl. G06T 17/00; G06T 7/00; G06V 10/764; G06V 10/774; G06V 20/70

(52) U.S. Cl. CPC G06T 17/00; G06T 7/0002; G06V 10/764; G06V 10/774; G06V 20/70; G06T 2207/10016; G06T 2207/20081; G06T 2207/30184

(57) ABSTRACT

Generating a 3D attention model from use of a trained classifier configured to generate an attention map from 2D image frames and a 3D reconstruction process configured to generate a 3D reconstructed representation from the 2D image frames, which can involve, for an input of the 2D image frames creating, through a 3D reconstruction process, the 3D reconstructed representation using the 2D image frames after data collection of an inspection process, the 3D reconstructed representation associated with a mapping to the 2D image frames; executing the trained classifier on the 2D image frames of the video to generate attention maps of the 2D image frames; projecting the attention maps of the 2D image frames to the 3D reconstructed representation based on the mapping to the 2D image frames; and storing the 3D attention model involving the associated 3D attention maps and the 3D reconstructed representation.

### BACKGROUND

### Field

The present disclosure is generally related to infrastructure inspection systems, and more specifically, to visual inspection analysis techniques.

### Related Art

Frequent infrastructure inspection is crucial to achieving safe and reliable societies. In the inspection process, inspectors confirm the condition of infrastructure such as sewers, tunnels, and bridges and record the location of any damage along with severity level. The recorded damage is used to forecast future collapse, and are fixed if they are severe enough to cause critical problems. Due to this inspection process, it can be possible to avoid experiencing interrupted utility services and serious injuries.

Visual inspection is one of the common infrastructure inspection methods, which enables inspectors to confirm any damage visually and record their information. In the visual inspection process, videos of target infrastructure are first captured, and then the captured videos are analyzed by professional or certified inspectors. Since inspectors can visually confirm the infrastructure surfaces, damage can be accurately evaluated, thereby improving the prediction of future collapse and enabling infrastructure owners to take prompt actions against potentially severe damage.

The analysis part of the visual inspection is typically time-consuming and laborious because inspectors must watch inspection videos thoroughly to avoid missing any signs of damage. If some signs of damage are missed during the inspection, the prediction of future collapse becomes inaccurate, thereby resulting in unexpected collapses. Thorough inspection is not a one-time task but a constant task and thus should be automated.

Video-analytics-based systems have been introduced for automation. In such systems, machine learning models process videos and output inspection information such as defect locations, defect sizes, and other observations. The information can be leveraged to identify frames with defects and observations in videos and thus help inspectors find signs of damage and skip frames involving infrastructure in regular conditions. As a result of machine-learning-based processes, the inspection time and labor costs can be reduced.

In the related art, there are systems and methods for structure defect detection using machine learning algorithms, using a vision-based defect detection method. In this related art method, the images of surfaces are fed into machine learning models, and then the models detect defects in the input images. Should the models find defects in the input images, the locations of the defects are displayed inside the images with visualization methods such as drawing bounding boxes and masking non-defect regions.

### SUMMARY

The related art solutions localize defects in frames and thus enable inspectors to find regions of defects inside frames easily. However, the defect localization approach requires a considerable annotation cost because the locations of defects inside frames must be specified to train machine learning models. The locations of defects are typically indicated by surrounding the regions with bounding boxes. A bounding box must be drawn for each defect inside a frame and precisely fit to each defect in order not to decrease the detection performance. Since a frame typically has multiple defects, multiple bounding boxes are drawn for each frame, and as a result, the annotation required takes a significant amount of time.

The related art solutions also have a limited capability for visualizing defect locations on infrastructures. The related art can display defect locations in frames, which helps inspectors find defect locations in frames. However, since the defect locations are displayed on each frame individually and are not associated with those of the previous and following frames, it can be time consuming to understand the condition of the infrastructures based on the condition of the locations around the current inspected locations. Inspectors need to change frames back and forth to figure out the condition and estimate the severity of defects in some contexts (e.g., continuous cracks, garbage accumulation inside sewer pipes), which increases the inspection time and leads to misunderstanding of the condition.

To address the issues with the related art, the example implementations described herein use machine-learning-based anomaly classifiers instead of defect detectors to find defects in frames and map the locations of defects in frames to reconstructed 3D infrastructure models.

Aspects of the present disclosure can involve a method for generating a 3D attention model from use of a trained classifier configured to generate an attention map from 2D image frames and a 3D reconstruction process configured to generate a 3D reconstructed representation from the 2D image frames, the method involving, for an input of the 2D image frames, creating, through a 3D reconstruction process, the 3D reconstructed representation using the 2D image frames after data collection of an inspection process, the 3D reconstructed representation associated with a mapping to the 2D image frames; executing the trained classifier on the 2D image frames of the video to generate attention maps of the 2D image frames; projecting the attention maps of the 2D image frames to the 3D reconstructed representation based on the mapping to the 2D image frames; and storing the 3D attention model comprising the associated 3D attention maps and the 3D reconstructed representation.

Aspects of the present disclosure can involve a system for generating a 3D attention model from use of a trained classifier configured to generate an attention map from 2D image frames and a 3D reconstruction process configured to generate a 3D reconstructed representation from the 2D image frames, the system involving, for an input of the 2D image frames, means for creating, through a 3D reconstruction process, the 3D reconstructed representation using the 2D image frames after data collection of an inspection process, the 3D reconstructed representation associated with a mapping to the 2D image frames; means for executing the trained classifier on the 2D image frames of the video to generate attention maps of the 2D image frames; means for projecting the attention maps of the 2D image frames to the 3D reconstructed representation based on the mapping to the 2D image frames; and means for storing the 3D attention model comprising the associated 3D attention maps and the 3D reconstructed representation.

Aspects of the present disclosure can involve a computer program having instructions for generating a 3D attention model from use of a trained classifier configured to generate an attention map from 2D image frames and a 3D reconstruction process configured to generate a 3D reconstructed representation from the 2D image frames, the computer program and instructions involving, for an input of the 2D image frames, creating, through a 3D reconstruction process, the 3D reconstructed representation using the 2D image frames after data collection of an inspection process, the 3D reconstructed representation associated with a mapping to the 2D image frames; executing the trained classifier on the 2D image frames of the video to generate attention maps of the 2D image frames; projecting the attention maps of the 2D image frames to the 3D reconstructed representation based on the mapping to the 2D image frames; and storing the 3D attention model comprising the associated 3D attention maps and the 3D reconstructed representation. The computer program and instructions can be stored on a non-transitory computer readable medium and executed by one or more processors.

Aspects of the present disclosure can involve an apparatus for generating a 3D attention model from use of a trained classifier configured to generate an attention map from 2D image frames and a 3D reconstruction process configured to generate a 3D reconstructed representation from the 2D image frames, the apparatus involving, a processor, configured to for an input of the 2D image frames, create, through a 3D reconstruction process, the 3D reconstructed representation using the 2D image frames after data collection of an inspection process, the 3D reconstructed representation associated with a mapping to the 2D image frames; execute the trained classifier on the 2D image frames of the video to generate attention maps of the 2D image frames; project the attention maps of the 2D image frames to the 3D reconstructed representation based on the mapping to the 2D image frames; and store the 3D attention model comprising the associated 3D attention maps and the 3D reconstructed representation.

### BRIEF DESCRIPTION OF DRAWINGS

FIG. 1 illustrates the overview of training the anomaly classifiers, in accordance with an example implementation.

FIG. 2 illustrates the overview of the inference phase, in accordance with an example implementation.

FIG. 3 illustrates the overview of the mapping phase, in accordance with an example implementation.

FIG. 4 illustrates examples of the training data, in accordance with an example implementation.

FIG. 5 illustrates the example flow of the annotation process for creating the training data, in accordance with an example implementation.

FIG. 6 illustrates the training process of anomaly classifiers, in accordance with an example implementation.

FIG. 7 illustrates the example flow of the classification process, in accordance with an example implementation.

FIGS. 8A and 8B illustrate heatmaps in accordance with an example implementation.

FIG. 9 illustrates the example flow of the reconstruction process, in accordance with an example implementation.

FIG. 10 illustrates the 3D attention model creation process, in accordance with an example implementation.

FIG. 11 shows an example of a graphical user interface (GUI) for visual inspection with inspectors, in accordance with an example implementation.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

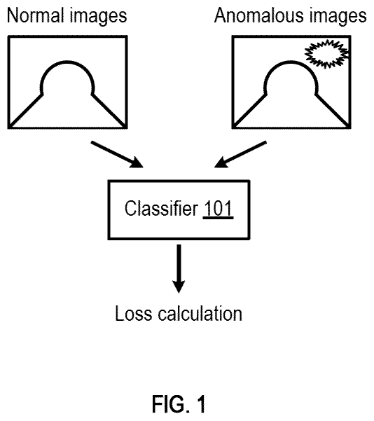

FIG. 1 illustrates the overview of training the anomaly classifiers, in accordance with an example implementation. To facilitate the example implementations described herein, machine-learning-based anomaly classifiers 101 are trained first. In this approach, anomaly classifiers 101 are trained to classify normal and anomalous images. Normal images are images that do not have any kinds of defects on the underlying infrastructure. Anomalous images are the images that have one or more defects on the underlying infrastructure. The classifiers 101 can be trained with any optimization algorithm known in the art, such as but not limited to stochastic gradient descent with neural networks. Since the annotations required is reduced to only labeling frames as normal or anomalous, the annotation required is therefore much more simplified than the defect detectors of the related art, thereby resulting in reducing the annotations costs and requirements.

The test is broadly split into two phases. The first phase is the inference phase, where a classification result and attention map of each frame are acquired from the trained machine-learning-based model. The 3D models of target infrastructures are also reconstructed in this phase. The second phase is the mapping phase, where the acquired image-based attention maps are mapped to the reconstructed 3D models.

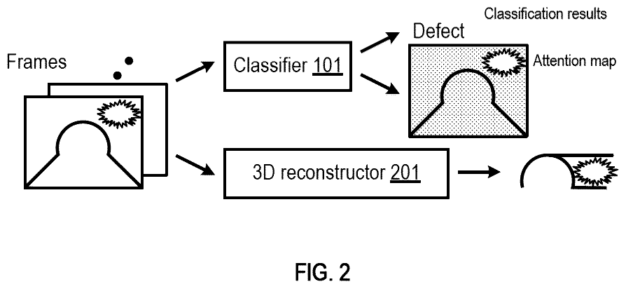

FIG. 2 illustrates the overview of the inference phase, in accordance with an example implementation. The frames of a captured video are fed into the trained anomaly classifier 101 to obtain anomaly scores, which show the possibility of having defects inside frames, and attention maps, which indicate the locations of defects inside frames. The 3D models can be reconstructed by applying typical 3D reconstruction algorithms 201 such as but not limited to structure-from-motion to input frames.

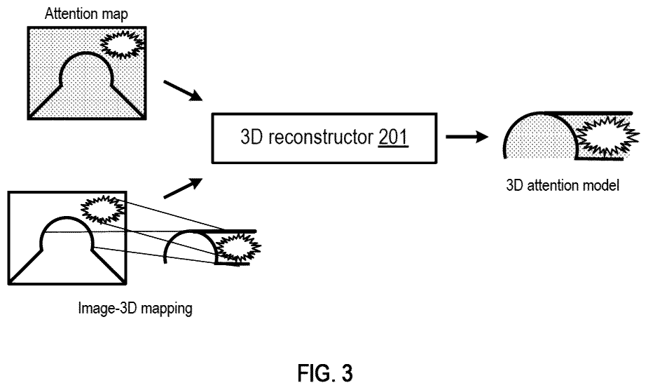

FIG. 3 illustrates the overview of the mapping phase, in accordance with an example implementation. The attention maps and image-3D mapping information obtained in the inference phase are used in this phase. The 3D models of the target infrastructures are reconstructed as in the inference phase. However, the surface colors of the 3D models are sampled from the obtained attention maps instead of the original input frames. The sampled colors are mapped to the 3D models based on the image-3D mapping output from the 3D reconstructor 201 from the inference phase. The reconstructed attention-based 3D models can provide comprehensive views of infrastructure conditions. Inspectors can thereby easily determine how many defects are around the current inspected locations and determine the damage severity based on the context.

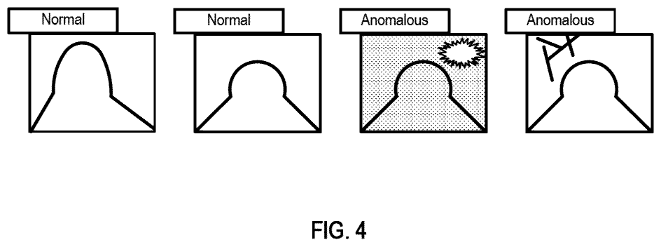

Training data is also prepared to train anomaly classifiers for visual inspection. FIG. 4 illustrates examples of the training data, in accordance with an example implementation. As shown in the figure, frames that capture normal surfaces of infrastructures are labeled as normal samples, while those with some defects are annotated as anomalous samples. The frames can be stored as image data, and the labels are commonly stored as text data. The image and label data are fed into machine learning models during training.

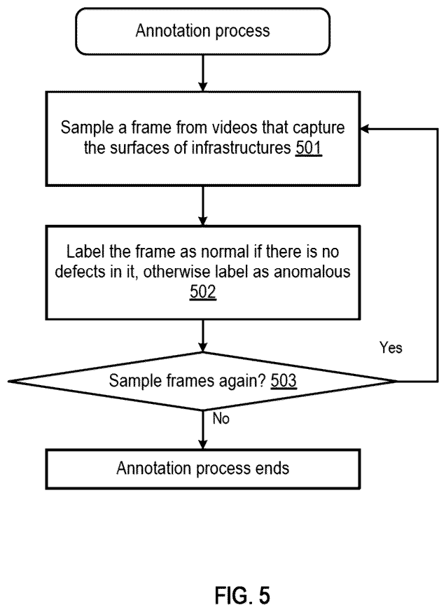

FIG. 5 illustrates the example flow of the annotation process for creating the training data, in accordance with an example implementation. In this process, a frame is sampled from videos that capture the surfaces of the infrastructure under inspection at 501. To improve the generalization capability of machine learning models, the diversity of appearance should be increased by sampling frames at a certain time interval. The sampled frame is shown to annotators, who then label it as normal or anomalous based on its appearance at 502. At 503, a determination is made as to whether additional frames are needed. If annotated frames are not enough to train machine learning models, and there are more frames to be sampled, the annotation process is repeated (Yes).

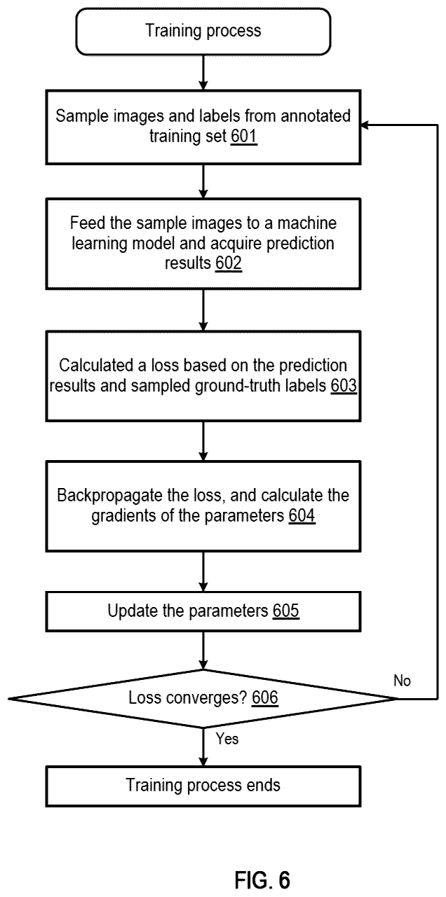

After training data is prepared, anomaly classifiers are trained with the data. FIG. 6 illustrates the training process of anomaly classifiers, in accordance with an example implementation. In this example training process, neural networks are assumed to be the machine learning models for anomaly classification. Some images and corresponding labels are first sampled from a training dataset at 601. The sampled images are then fed into neural networks to obtain prediction results at 602. The prediction results can involve values that indicate anomaly scores such as the probabilities of having defects in images. Training loss is calculated with the sampled ground-truth labels and obtained prediction results at 603. Since the anomaly classification is done as binary classification, binary cross entropy loss can be used to calculate the training loss. The loss is backpropagated to parameters in the neural networks to calculate gradients at 604, and the parameters are updated based on the gradients at 605. At 606, if the loss does not converge (No), then the training process is repeated from 601 by sampling a new set of images and labels.

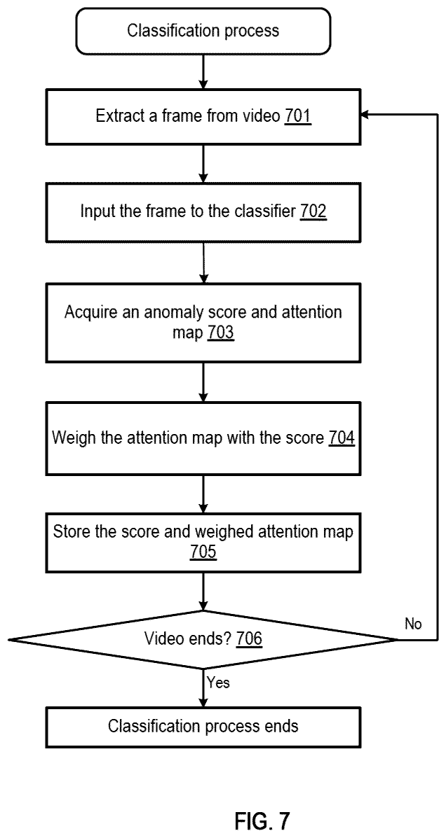

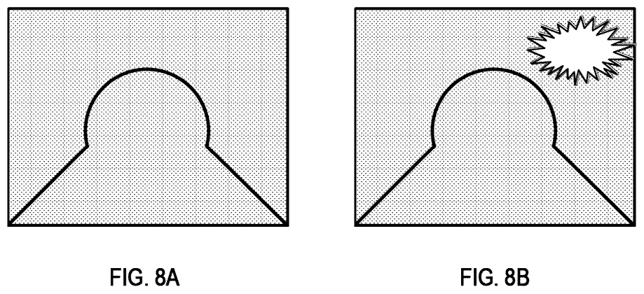

After the training, the trained anomaly classifier is deployed to classify anomalous frames and output attention maps. FIG. 7 illustrates the example flow of the classification process, in accordance with an example implementation. A video is first input into the visual inspection system and then split into frames at 701. The split frames are fed into the anomaly classifier to obtain prediction results at 702. The prediction result of each frame can involve an anomaly score and an attention map at 703. The anomaly scores can be indicative of the probabilities of having defects in images as in the training process, and the attention maps can be indicative of heatmaps that have high values on the locations of defects as depicted in FIG. 8A and FIG. 8B. At 704, the attention maps can be weighed by the anomaly scores so that the attention maps with low anomaly scores have low values everywhere in heatmaps as in FIG. 8A. The obtained anomaly scores and attention maps are stored to be used for visual inspection with visual inspectors at 705. At 706, if there are still non-processed frames (No), then the classification process is repeated from 701.

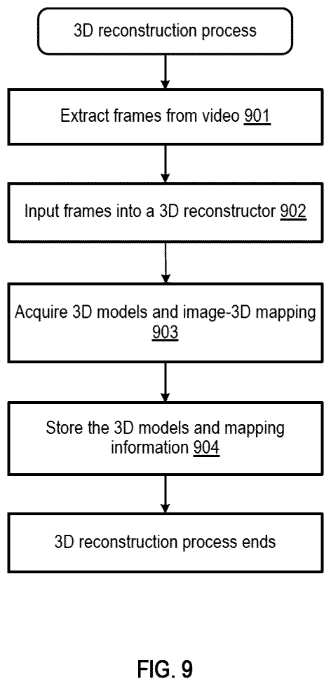

Along with the anomaly classification, 3D models of infrastructures are reconstructed with videos of them. FIG. 9 illustrates the example flow of the reconstruction process, in accordance with an example implementation. An input video is first split into frames as in the classification process at 901. The split frames are fed into a 3D reconstructor that uses a 3D reconstruction algorithm such as structure-from-motion to reconstruct 3D models at 902. Reconstructed 3D models and mapping information between images and 3D models are obtained from the 3D reconstructor at 903 and stored for visual inspection with visual inspectors at 904.

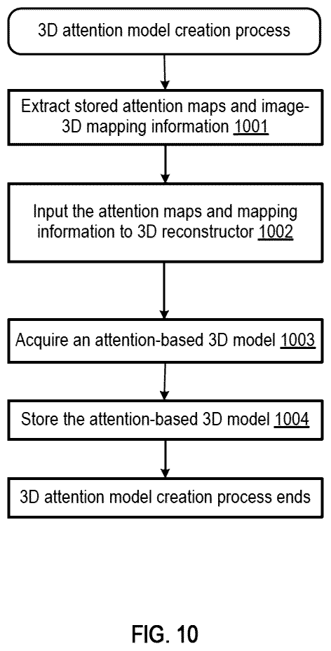

The attention maps are mapped to the 3D models with the obtained mapping information. FIG. 10 illustrates the 3D attention model creation process, in accordance with an example implementation. In this process, the stored attention maps and image-3D mapping information are first extracted at 1001 to map the attention values to the 3D models. The image-3D mapping information is input to the same 3D reconstructor used in the 3D reconstruction process at 1002. This process differs from the 3D reconstruction process in that the attention maps are used to sample the colors of 3D models instead of the original frames. As a result of this attention-map-based color sampling, 3D models with attention values can be reconstructed at 1003. The reconstructed attention-based 3D models are stored for visual inspection with visual inspectors at 1004.

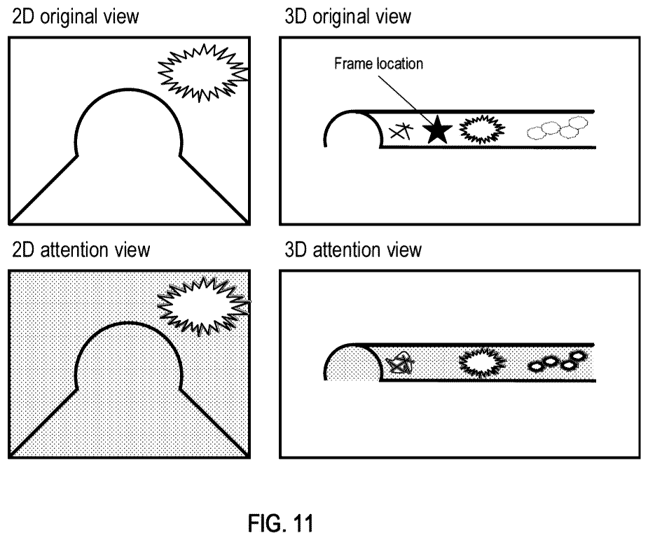

FIG. 11 shows an example of a graphical user interface (GUI) for visual inspection with inspectors, in accordance with an example implementation. Specifically, the GUI illustrates the 2D original view, 3D original view, 2D attention view, and the 3D attention view. As typical GUIs for inspection, the captured surface of a target infrastructure is displayed. The visual inspection system can select target inspection frames based on obtained anomaly scores. Low scores indicate that the frames likely have no defects and thus can be automatically skipped by setting a threshold of anomaly scores for displaying frames. This anomaly-score-based selection can reduce the inspection time. The attention map from the anomaly classifier is also displayed in the GUI. The attention maps can indicate the locations of defects in frames and thus help inspectors find where to focus inside frames. In addition to the original frame and attention map, the reconstructed 3D models are displayed. The 3D model reconstructed from the original frames can show the location of the displayed frame among the surrounding infrastructure parts. The 3D model reconstructed with attention maps can display how much the infrastructure is damaged around the current location, helping inspectors find the condition based on the context.

Since the example implementations only require frame-based annotations (e.g., labels which show if frames have defects or not), annotation costs for training machine learning models can be reduced drastically compared to the related art methods that require a bounding box annotation for each defect.

The example implementations can provide an efficient way of analyzing the infrastructure condition by showing focus areas in frames with attention maps as well as attention-based 3D models. Inspectors can easily find the infrastructure condition at the current location with those around the location, which also reduces the inspection time and help inspectors accurately evaluate the condition.

In addition, 3D models and image-3D mapping information can be obtained using 3D sensors such as stereo cameras and LiDARs instead of 3D reconstruction algorithms, depending on the desired implementation. With 3D sensors, depth information can be obtained for each 2D image frame. The depth information is combined with the frame to map pixels in 2D image frame to points in 3D coordinates. The obtained points are matched between frames based on a criterion such as Euclidian distance between points, thereby one 3D model can be generated with multiple frames, and image-3D mapping information is obtained. Because depth information obtained by 3D sensors is more accurate than that obtained by 3D reconstruction algorithm, generated 3D attention models can be more accurate than those generated with 3D reconstruction algorithm, resulting in accurate analysis of damages in infrastructures.

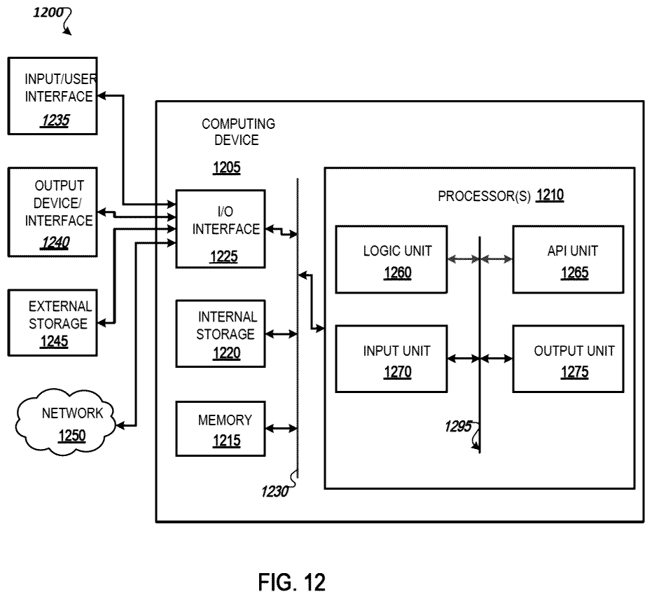

FIG. 12 illustrates an example computing environment with an example computer device suitable for use in some example implementations. Computer device 1205 in computing environment 1200 can include one or more processing units, cores, or processors 1210, memory 1215 (e.g., RAM, ROM, and/or the like), internal storage 1220 (e.g., magnetic, optical, solid-state storage, and/or organic), and/or IO interface 1225, any of which can be coupled on a communication mechanism or bus 1230 for communicating information or embedded in the computer device 1205. IO interface 1225 is also configured to receive images from cameras or provide images to projectors or displays, depending on the desired implementation.

Computer device 1205 can be communicatively coupled to input/user interface 1235 and output device/interface 1240. Either one or both of the input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via IO interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

IO interface 1225 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, the input unit 1270, the output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide an output based on the calculations described in example implementations.

Processor(s) 1210 can be configured to execute a method or instructions for generating a 3D attention model from use of a trained classifier configured to generate an attention map from 2D image frames and a 3D reconstruction process configured to generate a 3D reconstructed representation from the 2D image frames, which can involve, for an input of the 2D image frames, creating, through a 3D reconstruction process, the 3D reconstructed representation using the 2D image frames after data collection of an inspection process, the 3D reconstructed representation associated with a mapping to the 2D image frames; executing the trained classifier on the 2D image frames of the video to generate attention maps of the 2D image frames; projecting the attention maps of the 2D image frames to the 3D reconstructed representation based on the mapping to the 2D image frames; and storing the 3D attention model involving the associated 3D attention maps and the 3D reconstructed representation as illustrated in FIGS. 1 to 3, and 7 to 10.

Depending on the desired implementation, the trained classifier is trained against labeled 2D image frames classified as normal or anomalous and configured to output a classification for an input 2D image frame as normal or anomalous and an attention map indicating defects in the 2D image frames labeled as anomalous by the classifier as illustrated in FIGS. 1, and 4 to 6.

Processor(s) 1210 can be configured to execute the method or instructions as described above, wherein the executing the trained classifier involves, for an input of a 2D image frame from the 2D images frames, generating an attention map for the 2D image frame and an anomaly score; and weighing the generated attention map with the anomaly score as illustrated in FIG. 7.

Processor(s) 1210 can be configured to execute the method or instructions as described above, wherein the 3D reconstruction process involves, for an input of the 2D image frames, reconstructing a 3D image model from the 2D image frames; determining a mapping between the 2D image frames and the 3D image model; and providing the 3D image model and the mapping as the 3D reconstructed representation as illustrated in FIG. 9.

Processor(s) 1210 can be configured to execute the method or instructions as described above, and further involve providing a user interface configured to display the 2D image frames; the attention maps of the 2D image frames, the 3D reconstructed representation and the associated 3D attention maps as illustrated in FIG. 11.

Depending on the desired implementation, the 2D image frames are extracted from a recording of an infrastructure inspection video involving infrastructure undergoing the inspection process. Such infrastructure can involve any type of infrastructure subject to inspection, such as, but not limited to, pipelines, bridges, highways, sewer lines, and so on in accordance with the desired implementation.

Depending on the desired implementation, the 3D reconstruction process further utilizes 3D sensors (e.g., LiDAR, point clouds, etc.) to generate the 3D reconstructed representation.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for generating a 3D attention model from use of a trained classifier configured to generate an attention map from 2D image frames and a 3D reconstruction process configured to generate a 3D reconstructed representation from the 2D image frames, the method comprising:
for an input of the 2D image frames:
creating, through the 3D reconstruction process, the 3D reconstructed representation using the 2D image frames after data collection of an inspection process, the 3D reconstructed representation associated with a mapping to the 2D image frames;
executing the trained classifier on the 2D image frames to generate attention maps of the 2D image frames;
projecting the attention maps of the 2D image frames to the 3D reconstructed representation based on the mapping to the 2D image frames; and
storing the 3D attention model comprising the associated 3D attention maps and the 3D reconstructed representation.

2. The method of claim 1, wherein the trained classifier is trained against labeled 2D image frames classified as normal or anomalous and configured to output a classification for an input 2D image frame as normal or anomalous and the attention map indicating defects in the 2D image frames labeled as anomalous by the classifier.

3. The method of claim 1, wherein the executing the trained classifier comprises:
for the input of a 2D image frame from the 2D images frames:
generating the attention map for the 2D image frame and an anomaly score; and
weighing the generated attention map with the anomaly score.

4. The method of claim 1, wherein the 3D reconstruction process comprises:
for the input of the 2D image frames:
reconstructing a 3D image model from the 2D image frames;
determining the mapping between the 2D image frames and the 3D image model;
providing the 3D image model and the mapping as the 3D reconstructed representation.

5. The method of claim 1, further comprising providing a user interface configured to display the 2D image frames; the attention maps of the 2D image frames, the 3D reconstructed representation and the associated 3D attention maps.

6. The method of claim 1, wherein the 2D image frames are extracted from a recording of an infrastructure inspection video comprising infrastructure undergoing the inspection process.

7. The method of claim 1, wherein the 3D reconstruction process further utilizes 3D sensors to generate the 3D reconstructed representation.

8. A non-transitory computer readable medium, storing instructions for generating a 3D attention model from use of a trained classifier configured to generate an attention map from 2D image frames and a 3D reconstruction process configured to generate a 3D reconstructed representation from the 2D image frames, the instructions comprising:
for an input of the 2D image frames:
creating, through the 3D reconstruction process, the 3D reconstructed representation using the 2D image frames after data collection of an inspection process, the 3D reconstructed representation associated with a mapping to the 2D image frames;
executing the trained classifier on the 2D image frames to generate attention maps of the 2D image frames;
projecting the attention maps of the 2D image frames to the 3D reconstructed representation based on the mapping to the 2D image frames; and
storing the 3D attention model comprising the associated 3D attention maps and the 3D reconstructed representation.

9. The non-transitory computer readable medium of claim 8, wherein the trained classifier is trained against labeled 2D image frames classified as normal or anomalous and configured to output a classification for an input 2D image frame as normal or anomalous and the attention map indicating defects in the 2D image frames labeled as anomalous by the classifier.

10. The non-transitory computer readable medium of claim 8, wherein the executing the trained classifier comprises:
for the input of a 2D image frame from the 2D images frames:
generating the attention map for the 2D image frame and an anomaly score; and
weighing the generated attention map with the anomaly score.

11. The non-transitory computer readable medium of claim 8, wherein the 3D reconstruction process comprises:
for the input of the 2D image frames:
reconstructing a 3D image model from the 2D image frames;
determining a mapping between the 2D image frames and the 3D image model;
providing the 3D image model and the mapping as the 3D reconstructed representation.

12. The non-transitory computer readable medium of claim 8, the instructions further comprising providing a user interface configured to display the 2D image frames; the attention maps of the 2D image frames, the 3D reconstructed representation and the associated 3D attention maps.

13. The non-transitory computer readable medium of claim 8, wherein the 2D image frames are extracted from a recording of an infrastructure inspection video comprising infrastructure undergoing the inspection process.

14. The non-transitory computer readable medium of claim 8, wherein the 3D reconstruction process further utilizes 3D sensors to generate the 3D reconstructed representation.

15. An apparatus, comprising:
A processor, configured to:
for an input of 2D image frames:
create, through a 3D reconstruction process, a 3D reconstructed representation using the 2D image frames after data collection of an inspection process, the 3D reconstructed representation associated with a mapping to the 2D image frames;
execute a trained classifier on the 2D image frames to generate attention maps of the 2D image frames;
project the attention maps of the 2D image frames to the 3D reconstructed representation based on the mapping to the 2D image frames; and
store a 3D attention model comprising the associated 3D attention maps and the 3D reconstructed representation.
